(19) United States
(12) Patent Application Publication
(10) Pub. No.: US 2006/0226623 A1
(43) Pub. Date: Oct. 12, 2006

(54) IMPROVED SUSPENSION SYSTEM FOR A VEHICLE

(76) Inventors: Duane Coenen, Seymour, WI (US); Brian Kaster, Pulasi, WI (US)

Correspondence Address: LAW OFFICE OF STEVEN B. LEAVITT, L.L.P.;ATTN: JOHN PEMBERTON, 7405 BUCKSKIN COURT, FORT WORTH, TX, 76137, US

(21) Appl. No.: 11/279,563

(22) Filed: Apr. 12, 2006

Related U.S. Application Data
(60) Provisional application No. 60/670,336, filed on Apr. 12, 2005.

(51) Int. Cl. B60G 11/08

(52) U.S. Cl. 280/124.171

(57) ABSTRACT

The present invention is a suspension system for a vehicle such as the High Mobility Multi Wheeled Vehicle (HMMWV) or more commonly known as the HUMVEE. The suspension system comprises at least one overload spring, at least one centering plate, and at least two overload spring brackets. Installation of the suspension system consists of first attaching the center plate to the frame. Next, the overload spring bracket is mounted on the vehicle and then the overload springs are secured to the center plate and the overload spring bracket. In use, when a vehicle have the improved suspension system encounters a bump or any other obstacle that engages the suspension, the overload spring is compressed in the middle while the ends are raised which reduces the force on the existing suspension system.

This application claims the benefit of U.S. Provisional Application No. 60/670,336, filed Apr. 12, 2005, which is incorporated herein by reference.

### BACKGROUND OF THE INVENTION

1. Technical Field

The present invention relates to the field of suspensions and more particularly to the suspension for automotive vehicles.

2. Description of Related Art

Since at least as early as World War I, the United States Army had been looking for a fast, lightweight all-terrain reconnaissance vehicle. In early 1940, however, things became urgent as the Axis powers began to score victories in Europe and Northern Africa.

In 1940 the army was in desperate need for a fast, lightweight transport carrier and thus the Jeep was created. Willys Overland Jeep MB and Ford GPW were the two versions mostly produced during World War II. In fact, Willys and Ford built about 700,000 of the vehicle between 1941 and 1945. The jeep was a tremendous success in World War II and became the motorized symbol of the American army. However, by the 1970s it had become obsolete and in 1979 the Army began looking for a new High Mobility Multi-Purpose Wheeled Vehicle (HMMWV). The vehicle had to be efficient at moving soldiers and light equipment to the battlefield, technologically advanced, provide superior mobility in a tactical field environment and replace an assortment of vehicles, including: some M151s (¼-ton utility vehicles [the old “jeep”]), all M274s (¼-ton Mules), all M561s (1½-ton Gama Goats), and some M880s (1¼-ton pick-up trucks).

In the early 80's a prototype HMMWV, nicknamed HUMVEE, was created. The HUMVEE was air transportable, relatively easy to maintain, reliable, and nearly twice as durable as the Army required. One of the most important features of the HUMVEE was the superior mobility in a tactical field environment due in part to the high ground clearance and suspension. The HUMVEE is a light, highly mobile, diesel-powered, four-wheel-drive vehicle equipped with an automatic transmission

The HUMVEE being produced today, has retained the superior mobility and has a unique multipurpose platform capable of at least fifteen configurations including cargo/troop carriers, weapons carriers, ambulances, and shelter carriers that all share a common engine, chassis and transmission, with 44 interchangeable parts. Some of the platforms include armor or protective plates attached to the exterior of the HUMVEE. This armor adds a considerable amount of weight to the vehicle and reduces the mobility due to the added stress on the suspension.

What is needed is an apparatus that can be easily attached to a vehicle such as the HUMVEE and provide additional support to the existing suspension. The apparatus should be easy to install, not harm the vehicle, or cause excessive wear on the vehicle. It would also be beneficial if the apparatus had relatively few parts.

### SUMMARY OF THE INVENTION

The present invention is a suspension system for a vehicle. The suspension system comprises at least one overload spring, at least one U-bolt, at least one centering plate, and at least two overload spring brackets. The overload spring, centering plate, and overload spring brackets are made of steel or some other similar hard material. A vehicle to which the suspension system of the instant invention may be applied is the High Mobility Multi Wheeled Vehicle (HMMWV) or more commonly known as the HUMVEE. Although, the instant invention may be applied to any vehicle employing an A-Frame particularly those that are light, highly mobile, four-wheel-drive vehicles.

Installation of the suspension system on a HUMVEE or vehicle similar to a HUMVEE consists of first attaching the center plate to the frame. Then, the overload spring is attached to the center plate with the U-bolts. The U-bolts are not tightened but rather are allowed to remain loose so the ends of the overload springs are relatively free to move a limited distance. Next, the overload spring bracket is mounted proximate to the shock tower and the overload springs are secured to the overload spring bracket. Finally, the U-bolts are tightened.

In use, when a vehicle with the improved suspension encounters a bump or any other obstacle that engages the suspension, the overload spring is compressed in the middle while the ends are raised. This reduces the force on the existing suspension system. The result is an improved suspension such that when the HUMVEE is fitted with armor or additional weight is added to the vehicle, the mobility of the vehicle is not severely compromised.

Although the invention has been described with reference to one or more preferred embodiments, this description is not to be construed in a limiting sense. There is modification of the disclosed embodiments, as well as alternative embodiments of this invention which will be apparent to persons of ordinary skill in the art. Other features and advantages of the present invention will become apparent upon reading the following detailed description of embodiments of the invention, when taken in conjunction with the appended claims.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a front view of a suspension system in accordance with the present invention installed on a vehicle;

FIG. 2 is an exploded view of a suspension system in accordance with the present invention; and

FIG. 3 is a flow chart depicting the steps used to install the present invention on a vehicle.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

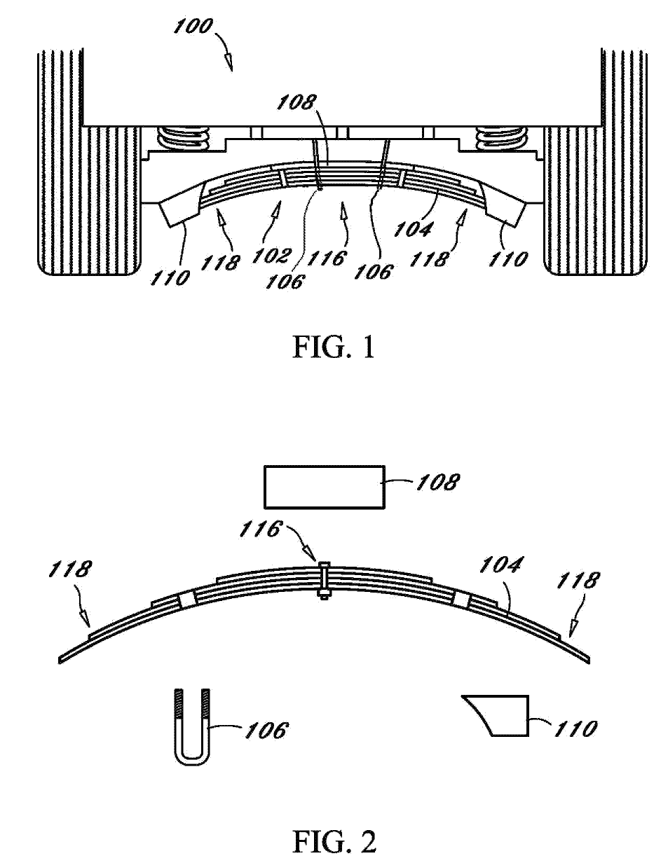

Referring to FIG. 1, shown is suspension system 102 for vehicle 100. Preferably, vehicle 100 is an A-frame vehicle. Suspension system 102 includes overload spring 104, U-bolts 106, centering plate 108, and overload spring brackets 110. Overload spring 104, U-bolt 106, centering plates 108, and overload spring brackets 110 are made of steel, armor plating, or some other similar hard material that is somewhat flexible, strong, and similar to the material used in the frame of vehicle 100. Preferably, U-bolt 106 is about ¾ inches and is made of tempered steel.

As shown in FIG. 1, center plate 108 is attached to the frame of vehicle 100 at about the highest point of the bottom of the suspension of vehicle 100. Center plate 108 supports overload spring 104. Further, center plate 108 and protects the frame of vehicle 100 from rocks and other debris. In one embodiment, more than one center plate 108 is used.

Center plate 108 is about 1 inch to about 4 feet long, about 6 inches to about 2.5 feet wide, and about ⅛ inch to about 1.5 inches thick. Center plate 108 is connected to and supports overload spring 104 via U-bolt 106.

Overload spring 104 is a standard leaf spring as is known in the art and has a middle section 116 and end sections 118 located at each terminal end. Middle section 116 of overload spring 104 is attached to center plate 108 via U-bolt 106. Overload spring 104 may contain more than one leaf spring and if more than one leaf spring is used, then the standard leaf spring may be cut to produce a layered structure as shown in FIG. 2. In one embodiment, each leaf spring is cut about 1 inch to about 3 inches shorter than the previous leaf spring. In another embodiment, each leaf spring is cut a sufficient distance such that overload spring 104 does not rub against the wheel of vehicle 100 during use. Preferably, 4 or 5 leaf springs comprise overload spring 104.

End section 118 of overload spring 104 is attached to vehicle 100 by overload spring bracket 110. Overload spring bracket 110 is fixedly attached to the frame of vehicle 100 proximate to the bottom of the shock tower or shock collar. In the preferred embodiment, overload spring bracket 110 is attached using the existing bolt and bolt holes on the frame of vehicle 100 that help secure the shock tower and the existing bolts are replaced with longer bolts to enable the attachment of overload spring bracket 110. Overload spring brackets 110 may be tapered to accommodate the wheels of vehicle 100 so that each wheel will not rub against overload spring bracket 110 when vehicle 100 is turning. Overload spring 104 is secured within overload spring bracket 110. In one embodiment, overload spring 104 is secured within overload spring bracket 110 by nylon bushings similar to a wear plate or by some other similar means as in know in the art.

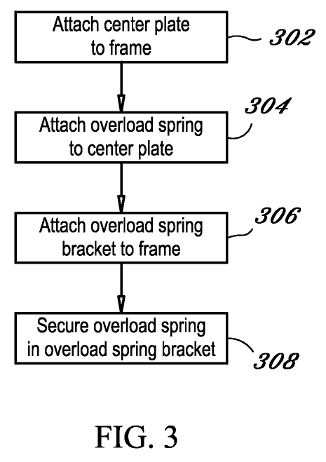

A vehicle to which the suspension system of the instant invention may be applied is the High Mobility Multi Wheeled Vehicle (HMMWV) or more commonly known as the HUMVEE. As shown in FIG. 3, the first step in the installation of the suspension system on a vehicle similar to a HUMVEE is to secure center plate 108 to the frame, Step 302. It should be noted that the suspension system could be installed on other vehicles and the use of the HUMVEE vehicle is only for illustrate purposes. In a typical HUMVEE, two frame rails are pinched together to make the vehicle's frame. The frame rails are secured to each other with bolts. Center plate 108 is secured to the frame using the original bolts to secure the two frame rails together. Preferably, center plate 108 is secured to the vehicle's 100 frame using existing bolts and bolt holes, or if longer bolts are required, using longer bolts and existing bolt holes, however, if needed, new bolt holes may be added into the vehicle's 100 frame to secure center plate 108, by for example adding drill holes.

After center plate 108 is secured to the HUMVEE, overload spring 104 is attached to centered plate 108 using U-bolts 106, Step 304. However, U-bolts 106 are not tightened but allowed to remain loose so end section 118 of overload spring 104 is relatively free to move a limited distance. Next, overload spring bracket 110 is mounted to the suspension system of the HUMVEE, Step 306. On a HUMVEE, overload spring bracket 110 is mounted proximate to the shock tower or shock collar and the existing bolt holes are used wherein the existing bolts are replaced with longer bolts to accommodate overload spring bracket 110. On a vehicle other than the HUMVEE, new bolt holes may have to be drilled. Then, overload spring 104 is secured to overload spring bracket 110, Step 308. Finally, U-bolts 106 are tightened and the improved suspension system is securely in place.

In use, when a vehicle with the improved suspension encounters a bump or any other obstacle that engages the suspension, the overload spring is compressed in the middle while the ends are raised. This reduces the force on the existing suspension system. The result is an improved suspension such that when the HUMVEE or other vehicle is fitted with armor or additional weight is added to the vehicle, the mobility of the vehicle is not compromised.

In addition, center plate 108 adds stability to the frame of vehicle 100. For example, without center plate 108, the frame of a HUMVEE can be bent over about 20 degrees which cause the HUMVEE to shut down and the frame must be straightened. With center plate 108 attached to the frame, the force to bent the frame over about 20 degrees is greatly increased. In addition, center plate 108 helps protect the frame from rocks and other debris.

Although the invention has been described with reference to one or more preferred embodiments, this description is not to be construed in a limiting sense. There is modification of the disclosed embodiments, as well as alternative embodiments of this invention which will be apparent to persons of ordinary skill in the art.

We claim:

1. A suspension system comprising:
at least one center plate secured to the frame of a vehicle;
at least one overload spring have two end sections and a middle section wherein the middle section is secured to the center plate; and
at least one overload spring bracket secured to the frame of the vehicle wherein the overload spring bracket is affixadlly disposed within the end of the overload spring.

2. The suspension system of claim 1 wherein the overload spring is comprised of at least one leaf spring.

3. The suspension system of claim 2 wherein the overload spring is comprised of four leaf springs.

4. The suspension system of claim 3 wherein the leaf springs are staggered such that the bottom leaf spring is longer than the leaf spring on top of it.

5. The suspension system of claim 1 wherein the center plate is attached to the frame using existing bolts and bolt holes.

6. The suspension system of claim 1 wherein the overload spring bracket is proximate to the suspension system of the vehicle.

7. The suspension system of claim 1 wherein the over load spring is mounted proximate to the shock tower.

8. The suspension system of claim 1 wherein the suspension system is installed on an A-frame vehicle.

9. The suspension system of claim 8 wherein the A-frame vehicle is a high mobility multi-wheeled vehicle.

10. A method for installing a suspension system on a vehicle, the method comprising the steps of:
securing at least one center plate to the frame of a vehicle;
securing at least one overload spring to the center plate wherein the center plate has two end sections and a middle section wherein the middle section is secured to the center plate; and
securing at least one overload spring bracket to the frame of the vehicle wherein the overload spring bracket is secured to the end of the overload spring.

11. The method of claim 10 wherein the overload spring is comprised of at least one leaf spring.

12. The method of claim 10 wherein the overload spring is comprised of four leaf springs.

13. The method of claim 12 wherein the leaf springs are staggered such that the bottom leaf spring is longer than the leaf spring on top of it.

14. The method of claim 10 wherein the center plate is attached to the frame using existing bolts and bolt holes.

15. The method of claim 10 wherein the overload spring bracket is proximate to the suspension system of the vehicle.

16. The method of claim 10 wherein the over load spring is mounted proximate to the shock tower.

17. The method of claim 10 wherein the suspension system is installed on an A-frame vehicle.

18. The method of claim 17 wherein the A-frame vehicle is a high mobility multi-wheeled vehicle.
